(19) United States
(12) Patent Application Publication
(10) Pub. No.: US 2002/0107326 A1
(43) Pub. Date: Aug. 8, 2002

(54) Conical-front breaker plate and flow method

(76) Inventor: Paul Hendess, Safety Harbor, FL (US)

Correspondence Address: BLANK ROME COMISKY & MCCAULEY, LLP, The Farragut Building, Suite 1000, 900 17th Street, NW, Washington, DC, 20006, US

(21) Appl. No.: 09/778,947

(22) Filed: Feb. 8, 2001

(51) Int. Cl. C08L 27/12

(52) U.S. Cl. 525/199

(57) ABSTRACT

The present invention is a breaker plate which is placed in the path of a polymer melt flow. The breaker plate has a cone-shaped center portion with holes therein, the cone-shaped center portion extending in a downstream direction of the polymer flow. The cone-shaped center portion decreases the downstream melt volume, provides a self-wiping surface on the downstream side so that no polymer accumulates and promotes the transition from a reverse velocity profile to a normal velocity profile.

### FIELD OF THE INVENTION

The present invention is directed to a method and apparatus for a breaker plate located between an extruder barrel and a extrusion head adapter. The breaker plate has a conical downstream surface which decreases the downstream melt volume, provides a self-wiping surface to discourage the accumulation and degradation of polymer, and promotes the transition from a reverse-melt velocity profile to a normal-melt velocity profile.

### BACKGROUND OF THE INVENTION

Breaker plates have been used in polymer extrusion processing for many years. Breaker plates are placed in the path of a polymer melt flow between an extruder barrel and an extrusion head adapter to (1) form a seal between the upstream extruder barrel and the downstream adapter, (2) to provide a pocket or recess on the upstream face of the breaker plate for holding a pack of wire filter screens, and (3) to provide a degree of back pressure to the extruder feed screw which the feed screw often requires to properly melt and mix the polymer.

Breaker plates in the prior art suffer from several drawbacks. First, optimal polymer flow diameter on the downstream side of the breaker plate is ⅓ to ¼ the flow diameter on the upstream side of the breaker plate. Prior art breaker plates do not facilitate the reduction in flow diameter on the downstream side of the breaker plate that is necessary to obtain the optimal flow diameter.

Second, traditional breaker plates have holes and surfaces on their downstream face which are normal to the direction of polymer flow. These holes and surfaces promote the accumulation, stagnation, and degradation of polymer.

Third, the velocity profile of the polymer flow exiting the breaker plate and entering a circular flow pipe must transition from a reverse-profile parabola to a normal-profile parabola. Traditional breaker plates do not facilitate this transition.

In view of the foregoing deficiencies, it would be desirable to have a breaker plate which facilitates the reduction in flow diameter, prevents polymer from accumulating on its downstream surface, and promotes the transition from a reverse-parabola to a normal-parabola velocity profile.

### SUMMARY OF THE INVENTION

The present invention is directed to a single and double conical breaker plate having a cone shaped surface on its downstream face. The cone-shaped design addresses the shortcomings found in the prior art. The single conical design decreases the downstream melt volume and provides a self-wiping surface on the downstream face that discourages the accumulation of polymer.

The double conical breaker plate design has a double-coned shaped surface on its downstream face. This design decreases the downstream melt volume, but not quite to the degree of the single conical design, provides a self-wiping surface on the downstream portion that discourages the accumulation of polymer, and promotes the transition from a reverse velocity profile to a normal velocity profile. Furthermore, both the single and the double conical breaker plate can also be made to retrofit existing extruders and adapters.

### BRIEF DESCRIPTION OF THE DRAWINGS

FIG. 1 is a perspective view of a prior art breaker plate having a flat downstream surface;

FIG. 1A is a side view of the breaker plate of FIG. 1;

FIG. 1B is a front view of the breaker plate of FIG. 1;

FIG. 2 is a crosshead flange assembly with a breaker plate mounted therein;

FIG. 3 shows a polymer melt entering a breaker plate;

FIG. 3A shows the velocity profile of the polymer melt of FIG. 3;

FIG. 4 shows the velocity profile of a polymer melt in a circular pipe after leaving a breaker plate;

FIG. 5 is a perspective view of a single conical breaker plate of the present invention;

FIG. 5A is a side view of the single conical breaker plate of FIG. 5;

FIG. 5B is a front view of the downstream side of the single conical breaker plate of FIG. 5;

FIG. 6 is a double conical breaker plate of the present invention;

FIG. 6A is a side view of the double conical breaker plate of FIG. 6; and

FIG. 6B is a front view of the downstream side of the double conical breaker plate of FIG. 6.

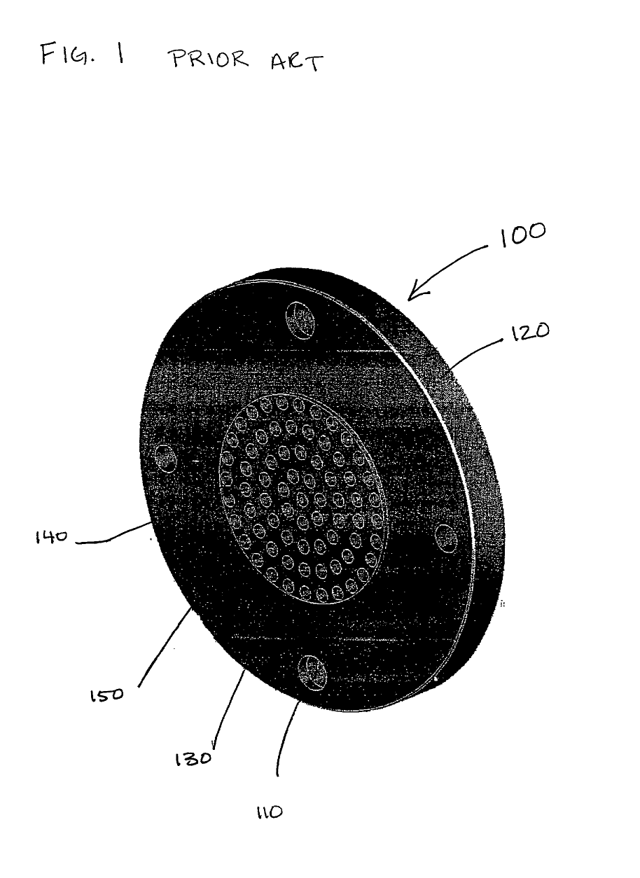

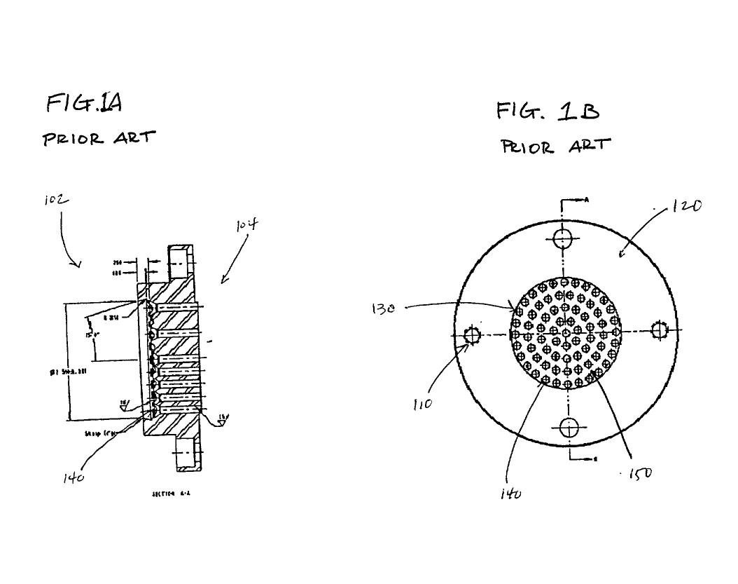

### DETAILED DESCRIPTION OF THE PREFERRED EMBODIMENTS

The present invention will be set forth in detail with reference to the drawings, in which like reference numerals refer to like components throughout.

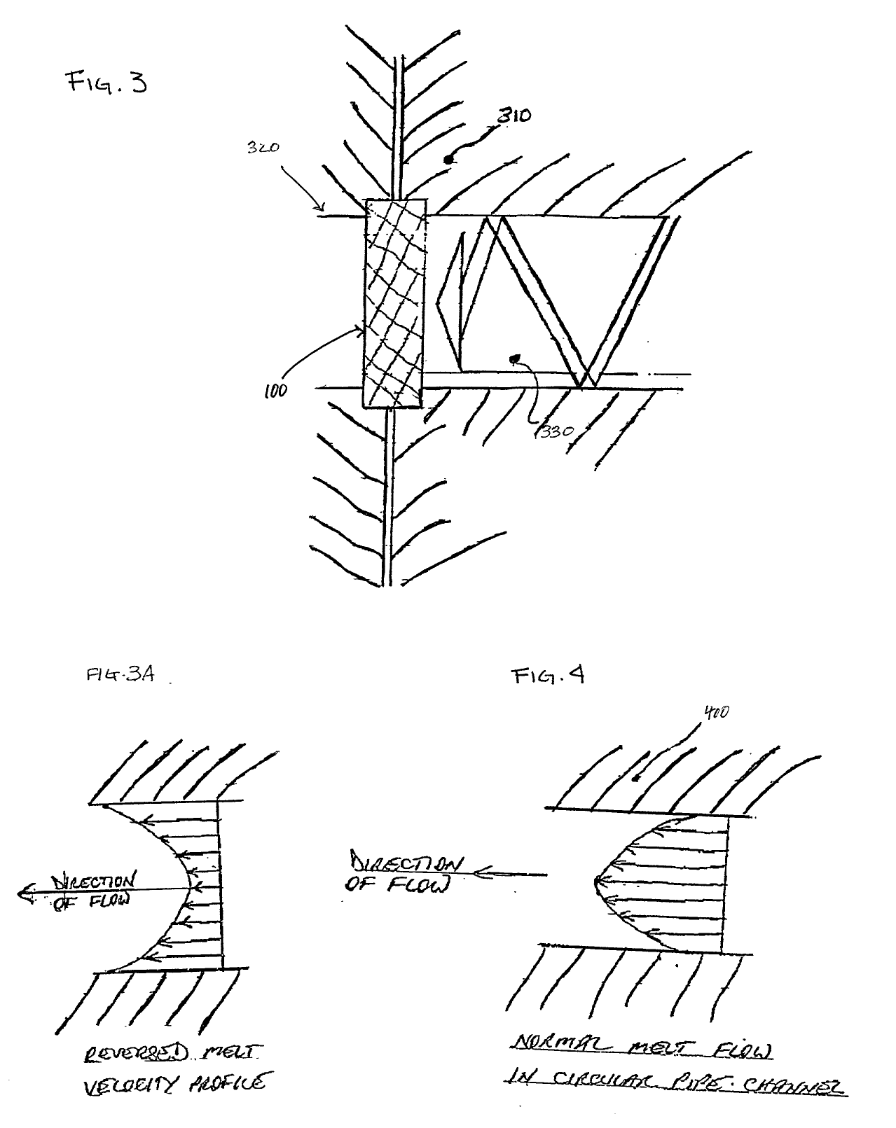

A typical breaker plate 100 is placed in the path of a polymer melt flow between an upstream extruder barrel 310 and a downstream extrusion head adapter 320, as shown in FIG. 3. The typical breaker plate 100 is a circular steel disk, flat on both sides, with drilled holes 140 therein that allow the polymer to flow through the plate.

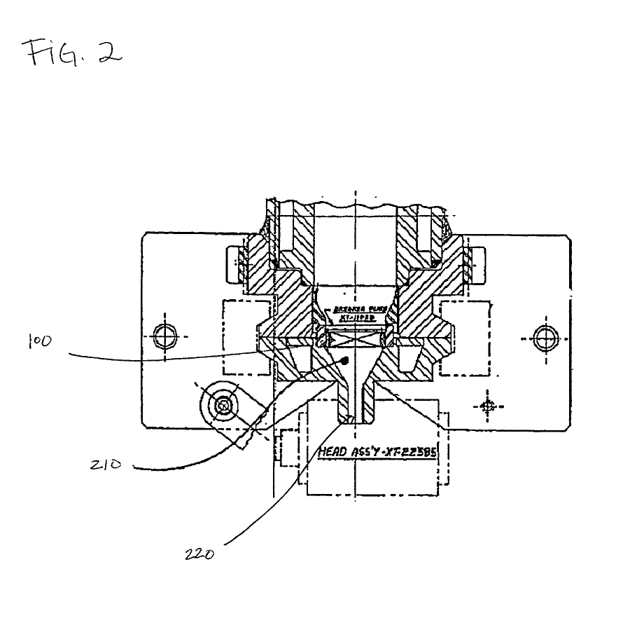

There are several problems with the conventional breaker plate design. First, because the flow area diameter on the upstream side of the breaker plate needs to match closely the feed screw diameter, and the drilled holes through the breaker plate are straight, the exiting downstream flow diameter is about the same as the entering flow diameter. However, the optimum exiting flow diameter is ⅓ to ¼ of the entering flow diameter, and a reduction in diameter needs to take place on the downstream side of the breaker plate in order to get to the optimal flow diameter 220. This reduction in polymer flow diameter is a smooth and gradual process and results in cone-shaped transition area 210, shown in FIG. 2. Since the diameter of the transition area 210 is larger than the optimal flow diameter 220, unwanted flow channel volume exists in the transition area 210 on the downstream side of the breaker plate. This unwanted volume results in the polymer having a longer residence time in the head assembly which increases the potential degradation of the polymer.

Second, the drilled holes 140 that begin on the upstream face 102 of the breaker plate 100, hold a wire filter screen pack (not shown), and are usually countersunk and overlapped to reduce or even eliminate any surfaces on the upstream breaker plate face that are normal or perpendicular to the polymer melt flow direction. The holes 140 on the downstream face 104 of the breaker plate are usually flat and not counterbored, so the surfaces on the downstream face of the breaker plate are normal to the direction of flow. It is these locations that are normal to the direction of flow which create stagnation areas 150 where polymer can accumulate, stall, stagnate, and degrade. This results in degraded polymer sticking to the breaker plate, eventually becoming loose and flowing unpredictably through the extrusion head and into the final product.

Third, as the polymer is delivered from the extruder feed screw 330, as shown in FIG. 3, the feed screw forces the polymer through the channel by applying pressure at the outer diameter of the feed screw and not at its central axis. Therefore, the velocity profile of the polymer coming from the extruder as it heads towards the breaker plate is a reverse-profile parabola, shown in FIG. 3A, where the velocity of the polymer flow is greatest at the perimeter.

Because the prior art breaker plate hole distribution is uniform, and the breaker plate is flat on both sides, the velocity profile of the polymer exiting the downstream face of the breaker plate will also be a reverse-profile parabola.

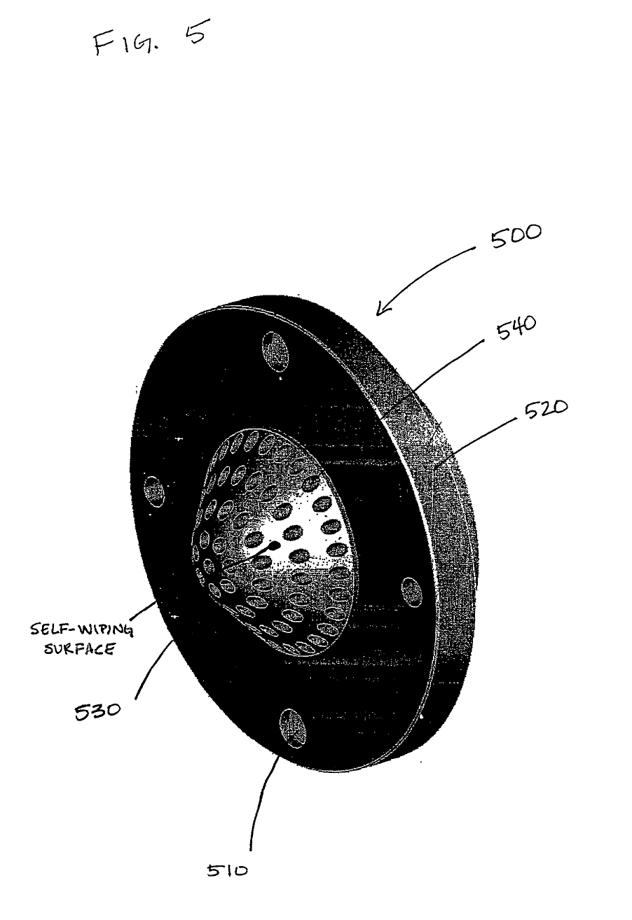

After leaving the breaker plate, the polymer melt goes into a circular flow channel or pipe 400, which is the most efficient way to transfer polymer melt. When the polymer flows through a 10 pipe, the greatest resistance to the polymer melt flow comes from the surface friction at the walls of the pipe. The least resistance to the polymer flow will be located at the center of the pipe. This condition creates a polymer velocity profile in the pipe that is parabolic in shape, with the velocity of the polymer greatest at it center, shown in FIG. 4.

The velocity profile transition from the reverse-profile parabola to the normal profile parabola (e.g., the profile transition from FIG. 3A to FIG. 4), results in the undesirable condition of having an unstable flow in the channel just downstream from the breaker plate.

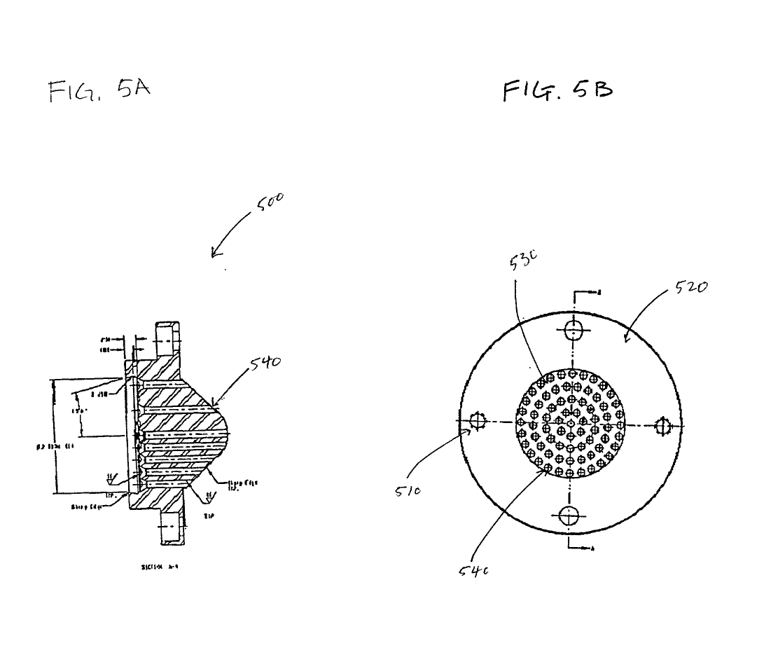

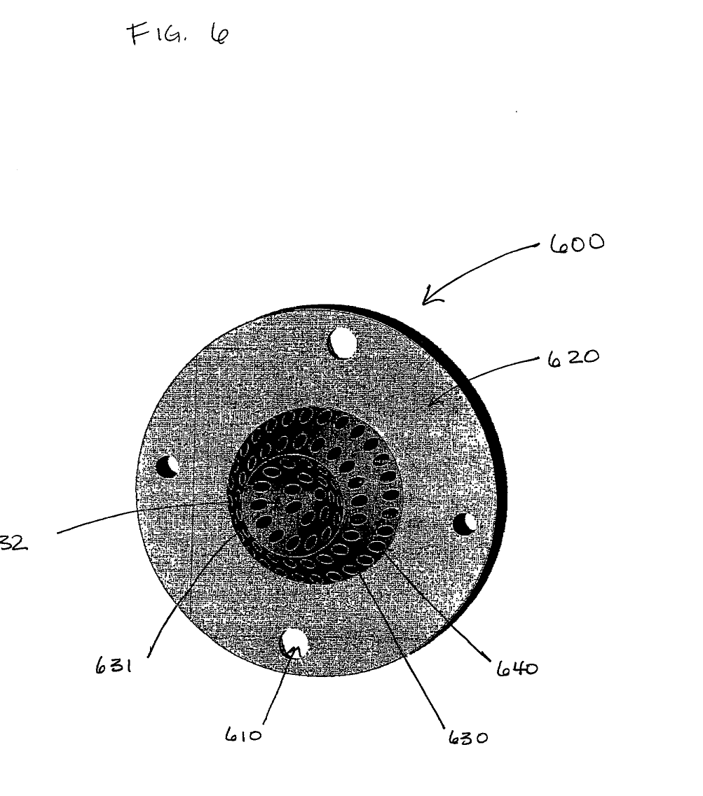

FIGS. 5, 5A, and 5B show a single conical breaker plate 500 which addresses the shortcomings of the prior art. The breaker plate 500 is fixed between an extruder barrel and a downstream head adapter by counter-bores 510 located in the ring plate 520. The center disk 530 of the breaker plate 500 is conical in shape. FIG. 5 shows the downstream side of the breaker plate, with its peak extending away from the breaker plate in the downstream direction. The center disk 530 has holes 540 through which the polymer flows through. The holes 540 lie on the surface of the cone such that none of the holes or surfaces on the center disk are normal to the direction of polymer flow, for reasons which will become apparent hereinafter.

This cone-shaped design addresses the shortcomings of the prior art. First, the cone shaped center disk 530 decreases the downstream polymer melt volume by physically occupying space on the downstream side. The cone occupies space so that there is less volume for the polymer melt to flow into. This decreases the amount of polymer melt residing downstream of the breaker plate, and consequently reduces the amount of time the polymer spends downstream of the breaker plate, and decreases polymer degradation.

Second, the conical surface on the center disk 530 of the breakerplate provides a self-wiping surface that discourages accumulation and stagnation of the polymer. Since polymer is more likely to accumulate on surfaces that are normal to flow, a breaker plate having a flat downstream surface, whose surface is normal to the direction of polymer melt flow, is likely to accumulate polymer at these surfaces. The polymer would then degrade and break off from the breaker plate and flow unpredictably into an extrusion head and eventually into the final product. The single conical breaker plate 500 has holes 540 on the surface of the center disk 530 which do not provide a normal surface to the direction of flow, and therefore discourages polymer accumulation on the downstream surface of the breaker plate.

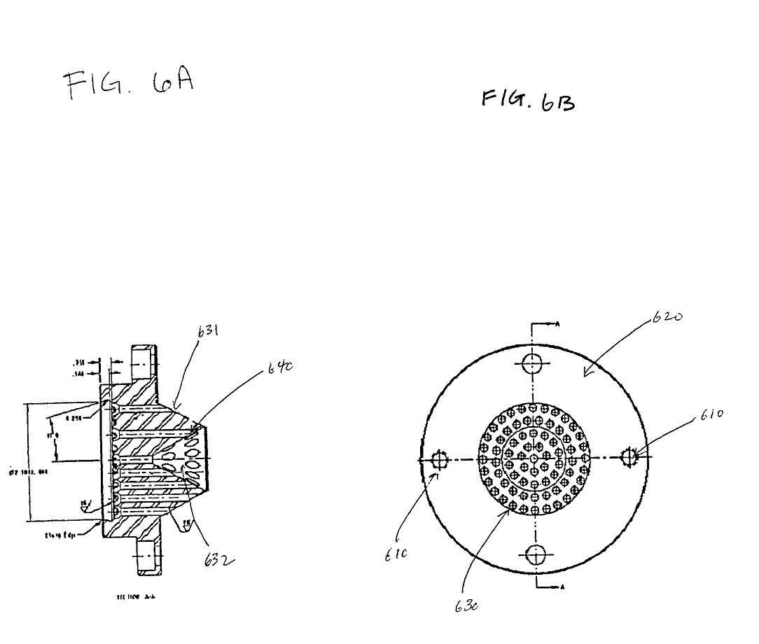

FIGS. 6, 6A, and 6B show an alternative embodiment of the present invention. The double conical breaker plate 600 is similar to the single conical breaker plate 500 except that its center disk 630 has a second internal cone 632. FIG. 6 shows a downstream side of the breaker plate 600, with the peak of the first cone 631 extending downstream away from the breaker plate, and the peak of the second internal cone extending upstream towards the breaker plate. The base of the second internal cone 632 coincides with the peak of the first cone 631, with the second cone turning inwardly on the interior of the first cone 631. Both cones have holes 640, none of whose surfaces are normal or perpendicular to the direction of polymer flow.

The double conical breaker plate 600 overcomes the drawbacks of the prior art discussed above. First, it decreases the downstream melt volume, but not to the degree of the single cone design. The cone-shaped center disk 630 physically occupies space downstream of the breaker plate 600 and decreases the polymer melt volume. However, because the second internal cone 632 turns inwardly of the first cone 631, this creates extra space internally of the second cone 632, which does not exist in the single conical breaker plate 500. Therefore, although the second conical breaker plate decreases the downstream melt volume, it is not as effective as the single conical breaker plate in this regard.

Additionally, the conical surface of the center disk 630 has no surfaces normal to the direction of flow and therefore discourages the accumulation and degradation of polymer for the same reasons as stated above with respect to the single conical design.

Furthermore, the double coned design promotes the flow velocity transition from a reverse profile parabola to a normal profile parabola by keeping the holes 640 near the center of the breaker plate as short as possible. Because the second cone 632 turns inward and back towards the base of the breaker plate 600, the holes on second cone 632 are closer to the base, and consequently are shorter than on a plate with a single conical surface. The short length of the holes 640 near the center of the disk 630 promote an increase in the flow velocity near the center of the disk 630, allowing a faster transition from the reverse velocity profile of FIG. 3A to the normal velocity profile shown in FIG. 4.

Although only preferred embodiments are specifically illustrated and described herein, it will be appreciated that many modifications and variations of the present invention are possible in light of the above teachings departing from the spirit and intended scope of the invention.

What is claimed is:

1. A breaker plate comprising:
a ring plate and a center disk with holes therein, wherein the center disk includes portions which are not parallel to the ring plate.

2. A breaker plate comprising:
a ring plate and a cone-shaped center disk with holes therein, wherein no portion of the center disk is parallel to the ring plate.

3. A breaker plate comprising:
a center disk having holes therein and extending in a downstream direction, wherein polymer flows through the breaker plate in the downstream direction,
wherein the center disk includes portions which are not perpendicular to the polymer flow direction.

4. A breaker plate comprising:
a cone-shaped center disk having holes therein and extending in a downstream direction, wherein polymer flows through the breaker plate in the downstream direction,
wherein no portion of the center disk is perpendicular to the polymer flow direction.

5. A breaker plate comprising:
a ring plate having counter bores to attach the breaker plate to an extruder barrel and a head adapter, wherein a polymer melt flows from the extruder barrel to the head adapter,
a center disk extending downstream of the breaker plate having holes therein, wherein the center disk includes portions which are not perpendicular to the polymer melt flow direction.

6. A breaker plate comprising:
a ring plate having counter bores to attach the breaker plate to an extruder barrel and a head adapter, wherein a polymer melt flows from the extruder barrel to the head adapter,
a cone-shaped center disk extending downstream of the breaker plate having holes therein, wherein no portion of the center disk is perpendicular to the polymer melt flow direction.

7. A breaker plate comprising:
a center disk having holes therein and extending in a downstream direction, wherein polymer flows through the breaker plate in the downstream direction, and
wherein the center disk provides a self-wiping surface.

8. A breaker plate comprising:
a center disk having holes therein and extending in a downstream direction, wherein polymer flows through the breaker plate in the downstream direction, and
wherein the center disk decreases the polymer melt volume downstream of the breaker plate.

9. A double conical breaker plate comprising:
a ring plate and a center disk having a first cone with holes therein, and a second cone with holes therein inside the first cone, wherein the first and second cones include portions which are not parallel to the ring plate.

10. A double conical breaker plate comprising:
a ring plate and a center disk having a first cone with holes therein, and a second cone with holes therein inside the first cone, wherein no portion of the first and second cones are parallel to the ring plate.

11. A double conical breaker plate comprising:
a cone-shaped center disk having a first cone with holes therein, the first cone extending in a downstream direction, a second cone with holes therein, the second cone being inside the first cone and extending in an opposite direction to the first cone, wherein polymer flows through the breaker plate in the downstream direction, and
wherein the first and second cones include portions which are not perpendicular to the direction of flow of the polymer melt.

12. A double conical breaker plate comprising:
a cone-shaped center disk having a first cone with holes therein, the first cone extending in a downstream direction, a second cone with holes therein, the second cone being inside the first cone and extending in an opposite direction to the first cone, wherein polymer flows through the breaker plate in the downstream direction, and
wherein no portion of the first and second cones are perpendicular to the direction of flow of the polymer melt.

13. A double conical breaker plate comprising:
a ring plate having counter bores to attach the breaker plate to an extruder barrel and a head adapter, wherein a polymer melt flows from the extruder barrel to the head adapter,
the breaker plate having a center disk having a first cone with holes therein, the first cone extending downstream of the breaker plate, a second cone with holes therein, the second cone being inside the first cone and extending in an opposite direction to the first cone, wherein the first and second cones include portions which are not perpendicular to the direction of flow of the polymer melt.

14. A double conical breaker plate comprising:
a ring plate having counter bores to attach the breaker plate to an extruder barrel and a head adapter, wherein a polymer melt flows from the extruder barrel to the head adapter,
the breaker plate having a center disk having a first cone with holes therein, the first cone extending downstream of the breaker plate, a second cone with holes therein, the second cone being inside the first cone and extending in an opposite direction to the first cone, wherein no portion of the first and second cones are perpendicular to the direction of flow of the polymer melt.

15. A double conical breaker plate comprising:
a cone-shaped center disk having a first cone with holes therein, the first cone extending in a downstream direction, a second cone with holes therein, the second cone being inside the first cone and extending in an opposite direction to the first cone, wherein polymer flows through the breaker plate in the downstream direction, and
wherein the center disk decreases the polymer melt volume downstream of the breaker plate.

16. A double conical breaker plate comprising:
a cone-shaped center disk having a first cone with holes therein, the first cone extending in a downstream direction, a second cone with holes therein, the second cone being inside the first cone and extending in an opposite direction to the first cone, wherein polymer flows through the breaker plate in the downstream direction, and
wherein the center disk provides a self-wiping surface.

17. A double conical breaker plate comprising:
a cone-shaped center disk having a first cone with holes therein, the first cone extending in a downstream direction, a second cone with holes therein, the second cone being inside the first cone and extending in an opposite direction to the first cone, wherein polymer flows through the breaker plate in the downstream direction, and
wherein the center disk promotes the transition from a reverse velocity profile to a normal velocity profile.

18. A method of extruding a polymer through a breaker plate to prevent the accumulation of polymer comprising the steps of:
providing a breaker plate with a center portion,
flowing a polymer melt through said center portion, and
wiping the center portion with the polymer melt flow to prevent the accumulation of polymer on the center portion.

19. A method of extruding a polymer through a breaker plate to decrease the downstream melt volume of the polymer comprising the steps of:
providing a breaker plate with a center portion extending in a downstream direction,
flowing a polymer melt through the breaker plate in a downstream direction,
occupying space downstream of the breaker plate with the center portion so that there is less available space for the polymer melt.

20. A method of extruding a polymer through a breaker plate to facilitate the transition from a reverse velocity profile to a normal velocity profile comprising the steps of:
providing a breaker plate with a center portion,
flowing a polymer melt through the breaker plate,
decreasing the velocity of the polymer melt around the perimeter of the center portion relative to the velocity of the polymer melt at the center of the center portion.
